(19) United States
(12) Patent Application Publication
(10) Pub. No.: US 2020/0131860 A1
(43) Pub. Date: Apr. 30, 2020

(54) Connecting Sucker Rods with Couplings Having Dry Film Lubrication

(71) Applicant: Weatherford Technology Holdings, LLC, Houston, TX (US)

(72) Inventors: Jeffrey L. Lembcke, Cypress, TX (US); John E. Stachowiak, JR., Houston, TX (US); Justin R. Galle, Houston, TX (US)

(21) Appl. No.: 16/170,825

(22) Filed: Oct. 25, 2018

(51) Int. Cl. E21B 17/042; F16N 3/00; F16N 15/00; C10M 125/22; C10M 107/38; C10M 169/04

(52) U.S. Cl. CPC E21B 17/042; F16N 3/00; F16N 15/00; C10M 125/22; C10N 2210/06; C10M 169/04; C10M 2201/066; C10M 2213/0623; C10M 107/38

(57) ABSTRACT

A sucker rod assembly for use downhole includes sucker rods and couplings. The sucker rods having pin connections with a pin face and a threaded pin. The coupling make up adjoining rods using box connections each having a box face and internal thread. Dry film lubrication is applied only to the internal thread of the couplings and excluded from the box face of the box connections. During make up, the dry film lubrication can help prevent seizing and/or galling of the threads for the connection between the coupling and the rods. The box connection is circumferentially displaced relative to the pin connection to place a preload on the pin, and the box face has a friction abutment with the pin face.

### BACKGROUND OF THE DISCLOSURE

Sucker rods are used for pump systems, such as sucker rod pumps or progressive cavity pumps, which extract fluids from a well and employ a downhole pump connected to a driving source at the surface. A rod string of sucker rods connects the surface driving force to the downhole pump in the well. In a reciprocating pump system, the downhole pump can be a positive displacement pump that utilizes a standing valve and a travelling valve. When operated, the driving source cyclically raises and lowers a downhole plunger, and with each stroke, the downhole pump lifts well fluids toward the surface.

For example, FIG. 1 shows a reciprocating pump system 10 used to produce fluid from a well. A downhole pump 14 has a barrel 16 with a standing valve 24 located at the bottom. The standing valve 24 allows fluid to enter from the wellbore, but does not allow the fluid to leave. Inside the pump barrel 16, a plunger 20 has a traveling valve 22, which allows fluid to move from below the plunger 20 to the production tubing 18 above, but does not allow fluid to return from the tubing 18 to the pump barrel 16 below the plunger 20. A driving source (e.g., a pump jack or pumping unit 26) at the surface connects by a rod string 12 to the plunger 20 and moves the plunger 20 up and down cyclically in upstrokes and downstrokes to lift fluid to the surface.

As shown in FIG. 1, the rod string 12 is comprised of multiple sucker rods 30 connected end-to-end by couplings 40. The sucker rods 30 and the couplings 40 have standards for design, manufacture, and assembly from the American Petroleum Institute (API). When installing the sucker rod string 12 in the field, each individual sucker rod connection between the couplings 40 and adjoining rods 30 must be made up properly.

Although lubrication may not be used on the threads of the connection, this can lead to improper connections and potential failure of the rod string 12. For instance, mechanical damage to the threads from thread galling can occur when damaged or contaminated threads rip and tear the thread surfaces during makeup. Hard stabbing damage to the leading thread may also cause thread galling of the connection. For these reasons, operators may clean the threads prior to make up and may take care in making up the connections. Moreover, operators typically apply lubricant by hand to the threads before making up each connection. This lubrication helps prevent seizing and/or galling of the threads for the connection between the coupling 40 and the rods 30.

Installation crews want to reduce the time it takes to install a sucker rod pump 14 and a rod string 12 in the ground so the well can begin producing fluids. During the sucker rod installation, however, the process of lubricating and making up the connections between the couplings 40 and adjoining rods 30 is repeated hundreds of times to create the length of the sucker rod string 12 from the surface equipment to the downhole pump 14. Having so many repeated steps increases the chances for applying lubricant incorrectly either by not getting enough lubrication on the threads, by applying too much lubricant on the threads, or by applying lubricant to areas that should not be lubricated. In the end, the misapplication of lubricant can cause the sucker rod connections to experience thread galling, to be torqued improperly, to result in connection failure by twisting off the pin on the end of the sucker rod 30, or to have the connection back off while the string 12 is reciprocating/turned downhole.

During installation, for example, a small amount of sucker rod lubricant is applied to the pin threads of the sucker rods 30. Some procedures may instead call for applying lubricant to the threads of the coupling 40. See e.g., Stevens, R. et al., “Protecting your investment in Sucker Rods—Part 2: Running and Re-Running,” Well Services, September/October 2005.

Guidance for installing the couplings on sucker rods has existed for some time and has particular instructions for making up the connections. For example, installation guidance emphatically states that “pins need to be lubricated prior to make up” and that pipe dope is not to be used. Instead, a combination of lubricant/oil soluble corrosion inhibitor is recommended. The guidance instructs operators to “[s]pray or dip the pins to provide a light coating. Do not pour lubricant into the boxes” of the coupling. See Patterson, J. C. et al., “Experience Reveals ways to Minimize Failures in Rod-Pumped Wells,” Oil & Gas Journal, dated Jul. 5, 1993.

This installation guidance continues to the present day. The effects of different thread lubricants on a sucker rod-coupling make up has been studied in detail. See Tietz, E. et al., “Lubricant Selection Using Circumferential Displacement of Sucker Rods,” Gas Well Deliquification Workshop, Feb. 25-27, 2008. Moreover, API Specification 11B, 27th ed. of May 2010 indicates that “anti-galling treatment applied to the coupling and sub-coupling threads shall be in accordance with manufacturer's specifications and used on all coupling and sub-coupling threads. It shall reduce the galling tendency during makeup of couplings, sucker rods, pony rods, or polished rods.” Therefore, “[s]election, type, amount, condition, method of application, and temperature rating of an acceptable thread lubricant” continues to recognized variable that affect sucker rod connection makeup. See Stevens, R, et al., “API RP 11BR Revisions on Sucker Rod Makeup,” 8th Annual Sucker Rod Pumping Workshop, Sep. 25-28, 2012. Accordingly, current instructions continue to call for providing correct application of lubricant. See Schlumberger, “Rod Lift Optimization Services,” Brochure, copyright 2015.

The connections between the coupling 40 and the pins on the adjoining sucker rods 30 are tightened together until hand-tight. A vertical line is drawn across the top end of the coupling 40 and the pin shoulder of the upper sucker rod 30. A Circumferential Displacement (CD) card placed at the connection is then used to measure and draw another vertical mark on the pin shoulder in the direction for tightening. This procedure is repeated for the bottom end of the coupling 40 and the lower sucker rod 30 held at the well floor with a gripper. A power tong is then used to complete the tightening, and operators use the marked circumferential displacement to turn the connection to a proper preload.

Conventional pipe couplings do not require the same considerations to lubricate their connections. For example, conventional pipe couplings are not connected using a specific displacement of stretch for preload on a pin end. Instead, conventional pipe couplings are connected using a specific torque placing the tapered connection between pipe couplings in compression.

In contrast to the torqued and compressed connections used in pipe couplings, the sucker rod connection is a rotary-shouldered, friction-loaded connection. During use, the sucker rod connection is subjected to cyclic loads as the rod string 12 is reciprocated in the well. Fatigue from such cyclic loading is reduced by placing preload on pins of the rods 30. Moreover, the friction on the bearing surface between the pin shoulders of the rods 30 and the face of the coupling 40 lock the connection together to both prevent dynamic torque during rod string rotation from twisting off the pin downhole and to prevent the connection from coming loose downhole. In this way, as long as the applied load during use remains less than the pin preload, the load in the connection remains constant and does not suffer from fatigue due to the cyclic loads. Should the preload to the pins be insufficient, however, higher applied loads can cause the coupling 40 and ends of the rods 30 to separate under the cyclic operation, eventually leading to failure.

The subject matter of the present disclosure is directed to overcoming, or at least reducing the effects of, one or more of the problems set forth above.

### SUMMARY OF THE DISCLOSURE

A method of manufacturing a sucker rod assembly is disclosed. The method comprises providing a sucker rod coupling having an internal bore and having first ends. Each of the first ends has a box connection, and each of the box connections has a box face on the first end and has an internal thread disposed about the internal bore. The method comprises applying lubricant only to the internal thread of the sucker rod coupling and excluded from the box faces; and curing the lubricant to a dry film lubrication on the internal thread.

The dry film lubrication can comprise a molybdenum disulfide (MoS₂) coating, a fluoropolymer coating, a coating of fluoropolymer compounds in a matrix of organic polymers, a coating using both polytetrafluoroethylene (PTFE) and molybdenum disulfide (MoS₂), or a mixture of a solid lubricant in a binder.

Applying the lubricant only to the internal thread of the sucker rod coupling and excluding from the box faces can comprise masking at least one of the box faces; and inserting an applicator having the lubricant into at least one of the first ends to apply the lubricant to at least a portion of the internal thread. For example, inserting the applicator having the lubricant can comprise inserting a wand having the lubricant disposed thereon into the internal bore and brushing the lubricant onto the internal thread. For example, inserting the applicator having the lubricant can comprise inserting a nozzle into the internal bore and spraying the lubricant from the nozzle onto the internal thread.

Applying the lubricant only to the internal thread of the sucker rod coupling and excluding from the box faces can comprise inserting an applicator having the lubricant into at least one of the first ends to apply the lubricant to at least a portion of the internal thread; and removing any excess of the lubricant from the box face of the at least one first end.

Applying the lubricant only to the internal thread of the sucker rod coupling and excluding from the box faces and curing the lubricant to the dry film lubrication on the internal thread can comprise inserting an applicator having the lubricant into at least one of the first ends to apply the lubricant to at least a portion of the internal thread; curing the lubricant to the dry film lubrication; and removing any excess of the dry film lubrication from the box face of the at least one first end.

Curing the lubricant to the dry film lubrication on the internal thread can comprises heating the coupling having the applied lubricant to a temperature.

The method can further comprise providing a plurality of sucker rods for the sucker rod assembly, each second end of the sucker rods having a pin connection, each pin connection having a pin shoulder with a pin face and having a pin extending from the pin face of the pin shoulder, each pin having an external thread disposed thereabout. In this case, a plurality of the sucker rod coupling can be provided for making up the second ends of adjoining ones of the sucker rods. The box faces on the first ends of the sucker rod couplings can thereby be configured to abut the pin faces of the pin connections.

A sucker rod assembly for use downhole, comprises a plurality of sucker rods and a plurality of sucker rod couplings. The sucker rods have first ends, and each of the first ends has a pin connection. Each pin connection has a pin shoulder with a pin face and has a pin extending from the pin face of the pin shoulder. The pin has external thread disposed about the pin.

The sucker rod couplings make up the first ends of adjoining ones of the sucker rods. Each of the couplings defines an internal bore between second ends, and each of the second ends has a box connection. Each of the box connections has a box face on the second end and has an internal thread disposed about the internal bore. Each of the couplings comprises a dry film lubrication applied only to the internal thread of the couplings and excluded from the box face of the box connections. Each box connection is configured to be circumferentially displaced relative to the pin connection with a preload on the pin, and each box face is configured to have a friction abutment with the pin face.

Each of the pin connections can define a pin relief between the pin face and the external thread. Each of the box connections can define a box relief between the box face and the internal thread. The dry film lubrication applied only to the internal thread of the couplings can be further excluded from the box relief of the box connections.

A method of assembling a sucker rod assembly is disclosed. The method comprises: lubricating couplings with a dry film lubrication applied only on internal thread and excluded from box faces of box connections on the couplings; connecting together adjoining sucker rods end-to-end using the couplings, each first end of the sucker rods having a pin connection, the pin connection having a pin shoulder with a pin face and having a pin extending from the pin face of the pin shoulder, the pin having external thread disposed about the pin; abutting the box and pin faces of the box and pin connections against one another; and applying a preload on the pins of the pin connections by circumferentially displacing the pin and box connections relative to one another.

Lubricating couplings with the dry film lubrication applied only on the internal thread and excluded from the box faces of box connections on the couplings can comprise: applying lubricant only to the internal thread of the couplings and excluded from the box face; and curing the lubricant to the dry film lubrication on the internal thread.

Applying the lubricant only to the internal thread of the coupling and excluding from the box face can comprise one of: (i) masking at least the box face and inserting an applicator having the lubricant into at least one second end of the coupling to apply the lubricant to at least a portion of the internal thread; (ii) inserting an applicator having the lubricant into at least one second end of the coupling to apply the lubricant to at least a portion of the internal thread and removing any excess of the lubricant from the box face of the at least one second end; and (iii) inserting an applicator having the lubricant into at least one second end of the coupling to apply the lubricant to at least a portion of the internal thread curing the lubricant to the dry film lubrication; and removing any excess of the dry film lubrication from the box face.

Curing the lubricant to the dry film lubrication on the internal thread can comprise heating the coupling having the applied lubricant to a temperature.

The dry film lubrication can comprise a molybdenum disulfide (MoS₂) coating, a fluoropolymer coating, a coating of fluoropolymer compounds in a matrix of organic polymers, a coating using both polytetrafluoroethylene (PTFE) and molybdenum disulfide (MoS₂), or a mixture of a solid lubricant in a binder.

Abutting the box and pin faces of the box and pin connections against one another can comprise tightening the box and pin connections hand tight.

Applying the preload on the pins of the pin connections by circumferentially displacing the pin and box connections relative to one another can comprise rotating at least one of the rods with a power tong.

The foregoing summary is not intended to summarize each potential embodiment or every aspect of the present disclosure.

### BRIEF DESCRIPTION OF THE DRAWINGS

FIG. 1 illustrates a reciprocating rod pump system according to the prior art.

FIG. 2 illustrates an elevational view of portion of a rod string having sucker rods connected to couplings according to the present disclosure.

FIG. 3A illustrates a detail of a connection between sucker rods with a coupling according to the present disclosure.

FIG. 3B illustrates a detail of a coupling according to the present disclosure disposed on pin ends of sucker rods.

FIG. 4 illustrates an assembly process according to the present disclosure.

FIGS. 5A-5B illustrate perspective views of a coupling with applicators according to the present disclosure.

FIG. 6 schematically illustrates a power tong relative to sucker rods and a coupling according to the present disclosure.

### DETAILED DESCRIPTION OF THE DISCLOSURE

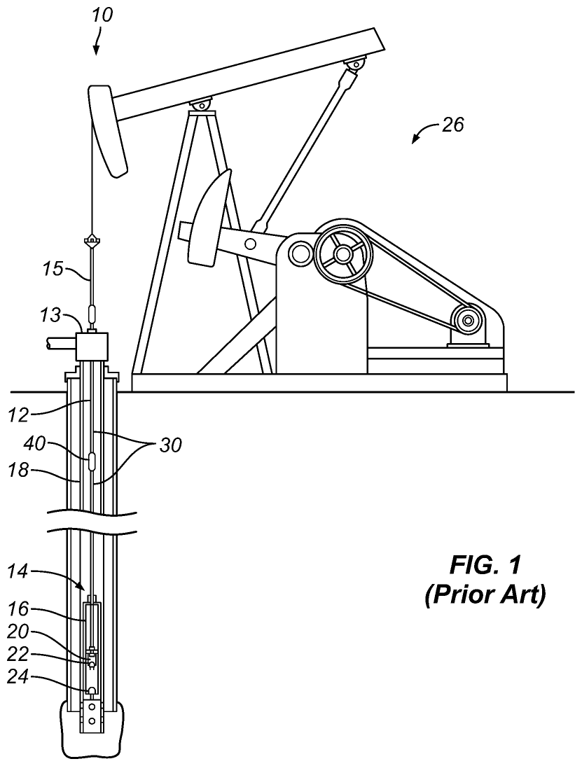

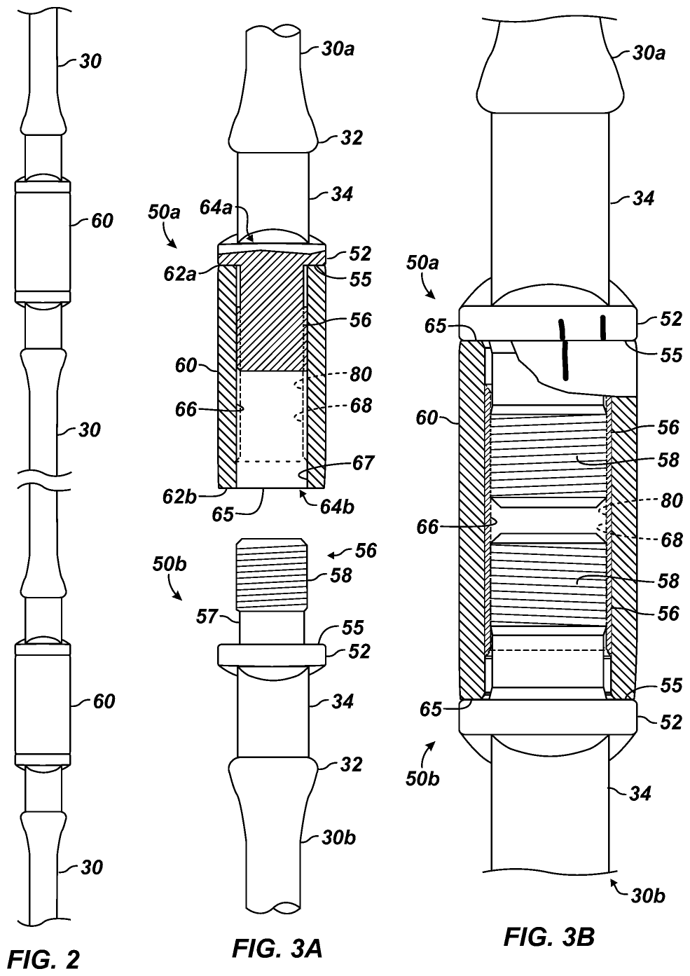

FIG. 2 illustrates an elevational view of a sucker rod assembly, which can be used with a reciprocating rod pump system as in FIG. 1 or with other artificial lift systems, such as a progressive cavity pump or the like.

The assembly includes a plurality of sucker rods 30 made-up end-to-end with a plurality of couplings 60. For each sucker rod connection, ends of the sucker rods 30 are screwed into opposite ends of the threaded rod couplings 60. In general, each sucker rod 30 can be 25 to 30-ft. (7.6 and 9.1-m) in length. Pony rods are similar, but considerably shorter for use near the surface. The sucker rod 30 can have any suitable diameter for the application at hand and typically has diameters of ⅝, ¾, 7/8, 1 and 1-⅛-in. The sucker rod 30 can be formed from a number of materials, such as carbon-manganese alloy steel, chromium-molybdenum alloy steel, nickel-molybdenum alloy steel, nickel-chrome steel, nickel-chromiumium molybdenum alloy steel, etc., suited to the application at hand.

For their part, the couplings 60 may be composed of a high strength alloy steel. The threads of the coupling 60 can be cut or can be cold formed by displacement of material. The coupling 60 also may have any suitable diameter for the application at hand and may typically have a length of about 4 to 4.5-in. Torque limits for the connections between the rods 30 and the coupling 60 depend on the materials used and the rod size, but the torque can range, for example, from 430 ft-lb. to as high as 3,7500 ft-lb.

FIG. 3A illustrates details of the ends of adjoining sucker rods 30a-b and the coupling 60 of the present disclosure. The adjoining sucker rods 30a-b each include a pin connection 50a-b that screws into the coupling 60. Typically, the rod's ends transition to a lipset bead 32 followed by a wrench square 34 having flats for tongs and other tools. The rod end then terminates in a pin shoulder 52 of the pin connection 50a-c. The pin shoulder 52 has a pin face 55 from which a pin 56 extends, and the pin 56 has external thread 58 disposed thereabout. The pin 56 can define a relief 57 between the pin face 55 and the external thread 58.

The coupling 60 for making up the ends of adjoining sucker rods 30a-b defines an internal bore 66 between ends 62a-b of the coupling 60. Each of the ends 62a-b has a box connection 64a-b. The box connection 64a-b has a box face 65 on the end 62a-b of the coupling 60, and the box faces 65 are configured to tightly abut the pin faces 55 of the adjoining rods 30a-b. The box connection 64a-b has an internal thread 68 disposed about the internal bore 66, and the box connections 64a-b can define a relief 67 between the box face 65 and the internal thread 68.

According to the present disclosure, the coupling 60 includes a dry film lubrication 80 applied only to the internal thread 68 of the coupling 60 (or at least to a portion thereof) and excluded from the box faces 65 of the box connections 64a-b. If desired, the dry film lubrication 80 can be further excluded from the relief 67 of the box connections 64a-b. The dry film lubrication is a coating of solid material (and a binder, resin, epoxy, or the like) for reducing friction and preventing galling of the coupling's threads 68.

The arrangement in FIG. 3A can represent one way for ends of the adjoining sucker rods 30a-b to be connected with the coupling 60. In general, the lower rod 30b can be held on the rig floor while previously connected sucker rods extend downhole. The upper rod 30a is lifted above the lower rod 30b to be coupled thereto with the coupling 60. Depending on the assembly procedures, the coupling 60 can initially be threaded onto either the upper or lower rod 30a-b. For example, operators may thread the coupling onto either of the upper or lower rod 30a-b at the rig floor, or the coupling 60 may have been threaded onto one of the ends before being lifted. Here, the coupling 60 is simply shown as being initially threaded on the pin 56 of the upper rod 30a. The upper rod 30a is lowered to the lower rod 30b, and the upper rod 30a is typically turned by hand to start the threading of the coupling 60 with the pin 56 of the lower rod 30b. Either way, the dry film lubrication 80 on the internal threads 68 can prevent seizing and/or galling of the threads 58, 68 between the pins 56 and the coupling 60, which may occur when making up the connection.

The connection is threaded hand tight with the box face 65 of the coupling 60 shouldering out against the pin face 55 of the sucker rod 30b. Operators are careful to ensure the abutment is clear of debris and that the threads align and mate properly. At this point, the connection between the sucker rods 30a-b is tightened further to complete the proper joint. For example, when the coupling is initially connected to the lower sucker rod 30b (opposite of FIG. 3A), a vertical line is drawn across the top end 62a of the coupling 60 and the pin shoulder 52 of the upper sucker rod 30a after hand-tightening. A Circumferential Displacement (CD) card placed at the connection is then used to measure and draw another vertical mark on the pin shoulder 52 in the direction for tightening as shown in FIG. 3B. This procedure is reversed when the coupling is initially connected to the upper sucker rod 30a as shown in FIG. 3A.

A power tong is then used to complete the tightening. For example, operators engage two sets of tong jaws on the power tong against the wrench flats 34 of the adjoining sucker rods 30a-b with the coupling 60 placed between them. During actuation of the power tong, one of the tong jaws rotates one rod (i.e., upper rod 30a in FIG. 3B) relative to the other rod 30b so pin 56 of the rod 30a screws into the coupling 60. Using the marked circumferential displacement, operators tighten the connection with the power tongs to a proper preload.

In the end, each box connection 64a-b is circumferentially displaced relative to the pin connection 50a-b with a preload placed on the pin 56, which is stretched longitudinally. Additionally, each box connection 64a-b to the pin connection 50a-b has a friction abutment between the mating faces 55, 65. In this way, the connection is a rotary-shouldered, friction-loaded connection. During use, the sucker rod connection is subjected to cyclic loads as the rod string (12) is reciprocated in the well or is subjected to rotation for use in progressing cavity pumping. Fatigue from such cyclic loading is reduced by placing the preload on the pins 56. Moreover, the friction between the pin face 55 and the coupling face 65 lock the connection together both prevent dynamic torque during rod string rotation from twisting off the pin downhole and to prevent the connection from coming loose downhole.

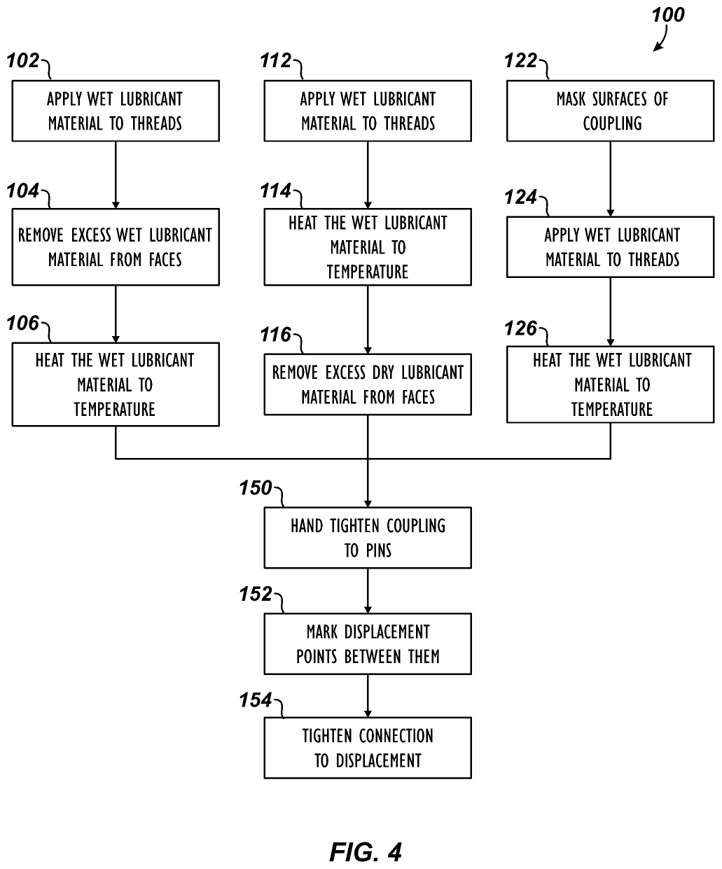

FIG. 4 illustrates a process 100 for manufacturing and assembling sucker rods 30 with couplings 60 according to the present disclosure. In general, the sucker rods 30 and couplings 60 are formed according to requirements with the various physical characteristics described above. The sucker rods 30 can be stored with end caps (not shown) to protect the shoulders 52, faces 55, pins 56, and threads 58 of the pin connections 50a-b during storage, shipping, and handling. The formed couplings 60, however, are prepared for anti-galling characteristics as noted herein.

In general and as noted above, base lubricant (i.e., the dry film lubrication in a “wet” form) is applied only to the internal thread 68 of the couplings 60 and is excluded from the box faces 65. The applied lubricant is then cured/heated to form the dry film lubrication 80 on the internal thread 68. The couplings 60 can then be properly protected with caps, wrapping, or the like to prevent dirt and debris from getting on the internal threads 68 during storage and eventually shipment and handling of the couplings 60 at a rig site.

Several application steps can be used for the dry film lubrication 80. In one example, base lubricant (i.e., the dry film lubrication 80 in its “wet” form) is applied with an applicator inserted into at least one of the ends 62a-b of the coupling 60 to lubricate at least a portion of the internal thread 68 (Block 102), and any excess of the base lubricant is removed from the box face 65 of the at least one second end 62a-b if present (Block 104). The applied lubricant is then cured/heated to produce the dry film lubrication 80 on the internal thread 68 (Block 106).

In another example, the base lubricant in its “wet” form is applied with an applicator into at least one of the ends 62a-b of the coupling 60 to lubricate at least a portion of the internal thread 68 (Block 112). The applied lubricant is then cured/heated to produce the dry film lubrication 80 (Block 114), and any residual dry film lubrication 80 can then be removed from the box face 65 and other surface as appropriate (Block 116).

In yet another example, surfaces of the coupling 60 can be masked using an adhered covering (Block 122). At least the box faces 65, for example, may be masked to prevent application of base lubricant to the faces 65. Base lubricant in the “wet” form is then applied to the internal threads 68 (Block 124). The applied lubricant is then cured/heated to leave the dry film lubrication 80 on the internal thread 68 once the masking is removed (Block 126).

The dry film lubrication 80 can be initially applied to the internal thread 68 by spraying or brushing the base lubricant onto the thread 68, dipping portion of the coupling 60 in the base lubricant, coating the thread 68 with a binder and dry-powder tumbling solid lubricant on the thread 68, and performing other application techniques. In general, the thickness of the dry film lubrication 80 may vary within an acceptable range deposited over the surface of the thread 68 that would withstand multiple (i.e., 5 to 10) make/break cycles in the field.

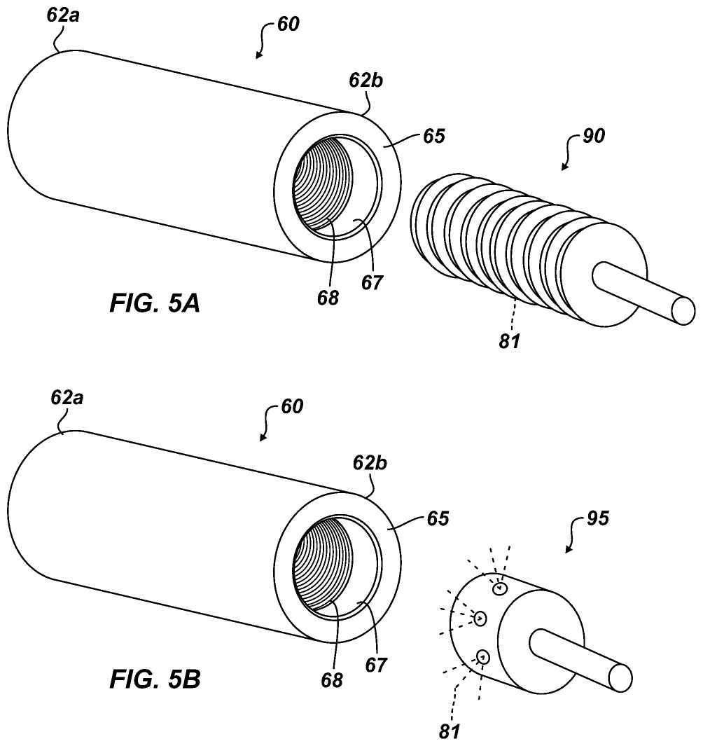

As noted above, for example, an applicator having the base lubricant can be inserted into at least one of the ends 62a-b of the coupling 60 to apply lubricant to at least a portion of the internal thread 68. Briefly, FIG. 5A illustrates an applicator wand 90 having the base lubricant 81 disposed thereon. The applicator wand 90 inserts into the internal bore 66 of the coupling 60 and brushes the base lubricant 81 onto the internal thread 68. The applicator wand 90 may be inserted into one or both ends 62a-b, which can be masked to prevent the base lubricant 81 from adhering to the faces 65 or can be cleaned of any residual lubricant 81 or any resulting dry film lubrication.

FIG. 5B illustrates a nozzle applicator 95 that inserts into the internal bore 66 of the coupling 60 and sprays the base lubricant 81 onto the internal thread 68. Depending on the precision of the spray operation, the faces 65 may not need to be masked, but the faces 65 can be cleaned if base lubricant 81 inadvertently gets on them.

As noted above, the applied lubricant is cured/heated to the dry film lubrication 80 on the internal thread 68. For example, the coupling 60 having the applied dry lubricant 80 can be baked to a temperature appropriate to cure/dry the base lubricant used to produce the dry film lubrication 80. Such a temperature would be considerably lower than any temperature that would structurally alter the material of the coupling 60 itself.

Particular types of dry film lubrication 80 for the internal thread 68 of the coupling 60 include a molybdenum disulfide (MoS₂) coating, a fluoropolymer coating, a coating of fluoropolymer compounds in a matrix of organic polymers, or a coating using both polytetrafluoroethylene (PTFE) and molybdenum disulfide (MoS₂), which can withstand high temperature applications and borehole fluids. Other forms of dry film lubrication 80 can be used. For example, the dry film lubrication 80 may comprise a mixture of a solid lubricant in a binder. Examples of solid lubricant can include particles of molybdenum disulfide (MoS₂), tungsten disulfide (WS₂), boron nitride, lead, zinc, copper, PTFE, graphite, zinc-phosphate coating, fluoropolymer, etc. The dry film lubrication 80 may comprise a coating incorporating very fine particles of lubricating pigment blended with a binder and other additives.

When assembling the sucker rods 30, the dry film lubrication 80 applied only on the internal thread 68 and excluded from the faces 65 of the box connections 64a-b on the coupling 60 helps to prevent issues with galling, and the lubricant free faces 65 have additional advantages noted herein.

FIG. 4 continues with steps for assembling the sucker rods 30 using the couplings 60 having the disclosed dry film lubrication 80. For example, adjoining sucker rods 30a-b are coupled together end-to-end using one of the couplings 60 by abutting the box and pin faces 55, 65 against one another hand-tight (Block 150). Operators can mark the displacement points between the pin shoulders 54 and the coupling 60 in the manner described previously (Block 152). The operators then apply a preload on the pins 56 of the pin connections 52a-b by circumferentially displacing the pin and box connections 52a-b, 64a-b relative to one another (Block 154). For example, a power tong can be used in a manner described previously.

The dry film lubrication 80 applied to the internal threads 68 can save both time and money in the field when assembling the sucker rods 30. Operators do not need to meticulously make sure each one of the hundreds of connections between rods 30 has the proper lubrication to assure a properly made-up joint. The lubrication to prevent galling is instead manufactured into the couplings 60 as the dry film lubrication 80, which can be more automated and controlled, versus being manually applied in a usually rushed and unchecked environment. The dry film lubrication 80 may also have benefits in the field when disassembling the sucker rods 30, such as when removing a rod string 12 and breaking the connections between the rods 30 and the couplings 60.

The dry film lubrication 80 specifically applied to internal threads 68 can eliminate the risk of getting unwanted lubricant between the pin and box faces 55, 65, as often occurs in the field practice. The contact between the pin face 55 and box face 65 requires friction to maintain a proper makeup. Lubrication in this contact area can increase the likelihood that the pin 56 will fail, or that the connection will back out in a progressive cavity pump system.

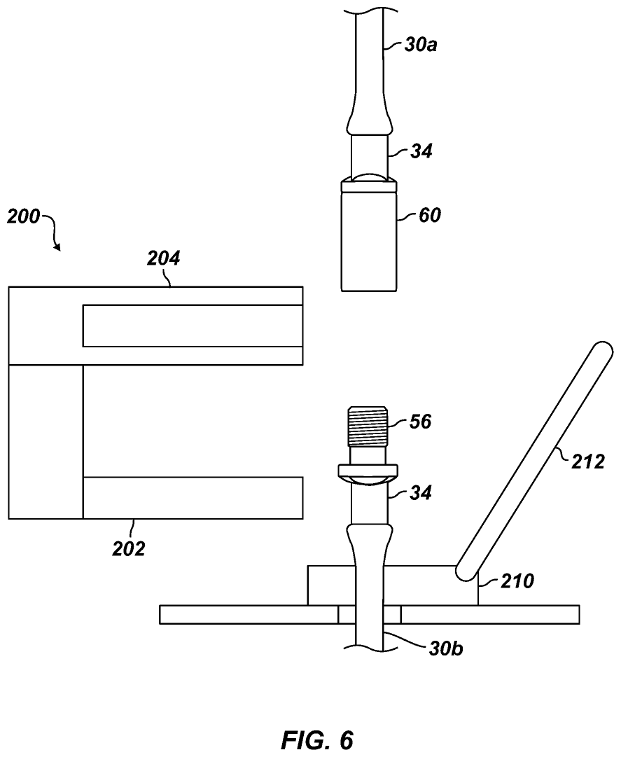

FIG. 6 schematically shows a power tong 200 in relation to sucker rods 30a-b for connection. A rod elevator 210 grips the lower rod 30b and has a hook 212 for lowering the rod 30b into the well. An upper sucker rod 30a has been hoisted upward using rod elevators (not shown) in a workover rig (not shown), while the lower sucker rod 30b is held in place using the rod elevator 210 to prevent the rod assembly from falling into the wellbore.

The coupling 60 is threaded hand tight to the pins 56 of the rods 30a-b. Manipulating the power tong 200, an operator engages a backup tong jaw 202 with the flats 34 on the lower sucker rod 30b below coupling 60 and engages an upper tong jaw 204 against the flats 34 of the upper sucker rod 30a above the coupling 60. While lower backup jaw 202 prevents rotation of the lower sucker rod 30b, the operator actuates the hydraulic system of the power tong 200 to rotate the upper tong jaw 204 to turn the upper rod 30a relative to the lower rod 30b.

Disassembling the sucker rods 30, such as when removing a rod string 12 and breaking the connections between the rods 30 and the couplings 60, would generally follow a reversal of the above steps as understood and are not described.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A method of manufacturing a sucker rod assembly, the method comprising:
providing a sucker rod coupling having an internal bore and having first ends, each of the first ends having a box connection, each of the box connections having a box face on the first end and having an internal thread disposed about the internal bore;
applying lubricant only to the internal thread of the sucker rod coupling and excluded from the box faces; and
curing the lubricant to a dry film lubrication on the internal thread.

2. The method of claim 1, wherein the dry film lubrication comprises a molybdenum disulfide (MoS₂) coating, a fluoropolymer coating, a coating of fluoropolymer compounds in a matrix of organic polymers, a coating using both polytetrafluoroethylene (PTFE) and molybdenum disulfide (MoS₂), or a mixture of a solid lubricant in a binder.

3. The method of claim 1, wherein applying the lubricant only to the internal thread of the sucker rod coupling and excluding from the box faces comprises masking at least one of the box faces; and inserting an applicator having the lubricant into at least one of the first ends to apply the lubricant to at least a portion of the internal thread.

4. The method of claim 3, wherein inserting the applicator having the lubricant comprises inserting a wand having the lubricant disposed thereon into the internal bore and brushing the lubricant onto the internal thread.

5. The method of claim 3, wherein inserting the applicator having the lubricant comprises inserting a nozzle into the internal bore and spraying the lubricant from the nozzle onto the internal thread.

6. The method of claim 1, wherein applying the lubricant only to the internal thread of the sucker rod coupling and excluding from the box faces comprises inserting an applicator having the lubricant into at least one of the first ends to apply the lubricant to at least a portion of the internal thread; and removing any excess of the lubricant from the box face of the at least one first end.

7. The method of claim 1, wherein applying the lubricant only to the internal thread of the sucker rod coupling and excluding from the box faces and curing the lubricant to the dry film lubrication on the internal thread comprises inserting an applicator having the lubricant into at least one of the first ends to apply the lubricant to at least a portion of the internal thread; curing the lubricant to the dry film lubrication; and removing any excess of the dry film lubrication from the box face of the at least one first end.

8. The method of claim 1, wherein curing the lubricant to the dry film lubrication on the internal thread comprises heating the coupling having the applied lubricant to a temperature.

9. The method of claim 1, further comprising:
providing a plurality of sucker rods for the sucker rod assembly, each second end of the sucker rods having a pin connection, each pin connection having a pin shoulder with a pin face and having a pin extending from the pin face of the pin shoulder, each pin having an external thread disposed thereabout; and
providing a plurality of the sucker rod coupling for making up the second ends of adjoining ones of the sucker rods, the box faces on the first ends of the sucker rod couplings configured to abut the pin faces of the pin connections.

10. A sucker rod assembly for use downhole, comprising:
a plurality of sucker rods having first ends, each of the first ends having a pin connection, each of the pin connections having a pin shoulder with a pin face and having a pin extending from the pin face of the pin shoulder, each of the pins having external thread disposed about the pin; and
a plurality of sucker rod couplings making up the first ends of adjoining ones of the sucker rods, each of the couplings defining an internal bore between second ends, each of the second ends having a box connection, each of the box connections having a box face on the second end and having an internal thread disposed about the internal bore, each of the couplings comprising a dry film lubrication applied only to the internal thread of the couplings and excluded from the box face of the box connections,
wherein each box connection is configured to be circumferentially displaced relative to the pin connection with a preload on the pin, and
wherein each box face is configured to have a friction abutment with the pin face.

11. The assembly of claim 10, wherein each of the pin connections defines a pin relief between the pin face and the external thread.

12. The assembly of claim 11, wherein each of the box connections defines a box relief between the box face and the internal thread.

13. The assembly of claim 12, wherein the dry film lubrication applied only to the internal thread of the couplings is further excluded from the box relief of the box connections.

14. A method of assembling a sucker rod assembly, the method comprising:
lubricating couplings with a dry film lubrication applied only on internal thread and excluded from box faces of box connections on the couplings;
connecting together adjoining sucker rods end-to-end using the couplings, each first end of the sucker rods having a pin connection, the pin connection having a pin shoulder with a pin face and having a pin extending from the pin face of the pin shoulder, the pin having external thread disposed about the pin;
abutting the box and pin faces of the box and pin connections against one another; and
applying a preload on the pins of the pin connections by circumferentially displacing the pin and box connections relative to one another.

15. The method of claim 14, wherein lubricating couplings with the dry film lubrication applied only on the internal thread and excluded from the box faces of box connections on the couplings comprises:
applying lubricant only to the internal thread of the couplings and excluded from the box face; and
curing the lubricant to the dry film lubrication on the internal thread.

16. The method of claim 15, wherein applying the lubricant only to the internal thread of the coupling and excluding from the box face comprises one of:
masking at least the box face and inserting an applicator having the lubricant into at least one second end of the coupling to apply the lubricant to at least a portion of the internal thread;
inserting an applicator having the lubricant into at least one second end of the coupling to apply the lubricant to at least a portion of the internal thread and removing any excess of the lubricant from the box face of the at least one second end; and
inserting an applicator having the lubricant into at least one second end of the coupling to apply the lubricant to at least a portion of the internal thread curing the lubricant to the dry film lubrication; and removing any excess of the dry film lubrication from the box face.

17. The method of claim 15, wherein curing the lubricant to the dry film lubrication on the internal thread comprises heating the coupling having the applied lubricant to a temperature.

18. The method of claim 14, wherein the dry film lubrication comprises a molybdenum disulfide (MoS₂) coating, a fluropolymer coating, a coating of fluoropolymer compounds in a matrix of organic polymers, a coating using both polytetrafluoroethylene (PTFE) and molybdenum disulfide (MoS₂), or a mixture of a solid lubricant in a binder.

19. The method of claim 14, wherein abutting the box and pin faces of the box and pin connections against one another comprises tightening the box and pin connections hand tight.

20. The method of claim 14, wherein applying the preload on the pins of the pin connections by circumferentially displacing the pin and box connections relative to one another comprises rotating at least one of the rods with a power tong.
